(19) United States
(12) Patent Application Publication
(10) Pub. No.: US 2006/0192678 A1
(43) Pub. Date: Aug. 31, 2006

(54) Ice dam warning system

(76) Inventor: Michael Garabedian, Newton, MA (US)

Correspondence Address: LAW OFFICE OF BRETT N. DORNY, 386 WEST MAIN STREET, SUITE 12A, NORTHBOROUGH, MA, 01532, US

(21) Appl. No.: 11/065,863

(22) Filed: Feb. 25, 2005

(51) Int. Cl. G08B 21/00

(52) U.S. Cl. 340/605

(57) ABSTRACT

A sensor system is used to detect water leaks caused by ice dams. The sensor system includes one or more water sensors having elongated leads. The elongated leads are placed inside the roof structure at locations where leaks are likely to occur. Upon detection of a leak, the sensor sends an RF or other signal to a receiver. The receiver provides a warning of the leak to the building owner or operator.

### BACKGROUND OF THE INVENTION

1. Field of the Invention

The present invention relates to sensing systems. More particularly, it relates to a system for sensing the presence of water leaks caused by ice dams.

2. Discussion of Related Art

Ice dams can be a major problem for buildings in areas which receive moderate to heavy amounts of snow. An ice dam is a ridge of ice that forms at the edge of a roof and prevents melting snow (water) from draining off the roof. Ice dams are formed when portions of a roof of a building have different temperatures around the freezing point. There is a complex interaction among the amount of heat loss from a building, snow cover, and outside temperatures that leads to ice dam formation. FIG. 1 illustrates the creation of an ice dam. FIG. 1 is a cross section of a portion of building around the roof 10. A room 15 is formed between an exterior wall 11 and a ceiling 12 under the roof 10. A second room 16 is formed in the attic space. The second room 16 has an interior wall 13 and an angled ceiling 14 along the roof 10. The second room 16 leaves an empty space 17 in the attic above the first room 16. Insulation 31, 32, 33, 34 is placed in the walls and ceilings of the rooms.

Snow 22 present on a roof melts due to heat loss through the roof. Heat losses may be caused by inadequate insulation, air leakage or other reasons. The melting snow flows down the roof until it reaches the eaves. Since the eaves of the roof extend beyond the building, their temperature is affected by the ambient air temperature. When the ambient air temperature is below the freezing point of water, the melted snow can freeze, forming the ice dam 20. The dam grows as it is fed by the melting snow above it, but it will limit itself to the portions of the roof that are, on average, below the freezing point of water. So water 21 from the melting snow backs up behind the ice dam and remains a liquid. This water finds cracks and openings in the exterior roof covering and flows into the attic space. From the attic it could flow into exterior walls or through the ceiling insulation and stain the ceiling finish.

The water which backs up into the building can cause significant damage. It flows into the ceilings and walls. This water weakens the structural and non-structural elements of the building. The ceiling or wall may need to be replaced because it has been weakened by water. Wet insulation is less effective and allows greater heat losses. Also, wet insulation in a wall can settle leaving empty spaces 35 with greater heat losses. Water in the building may also cause mold and mildew, with accompanying significant health risks. By the time water stains become visible on the ceiling or wall, a significant amount of water is present in the building.

Various systems have been devised to warn of ice dams. Most of these systems include multiple temperature sensors for determining the temperatures at various locations of the roof. These systems attempt to warn of the conditions under which an ice dam may form. However, due to the complex interaction of conditions which causes ice dams, such systems are not accurate. There are no sensor systems for determining the actual presence of an ice dam or its effects.

### SUMMARY OF THE INVENTION

The present invention is a system for detecting water leaks resulting from ice dams. The invention includes a water sensor and an elongated sensor lead placed inside the roof of a building. A warning system receives a signal from the sensor upon detection of a water leak and provides a notification. According to an aspect of the invention, the notification is an audio and/or visual alarm. According to another aspect of the invention, the warning system includes an autodialer for calling a preprogrammed telephone number. According to another aspect of the invention, the sensor sends an RF signal to the warning system upon detection of a water leak.

According to another aspect of the invention, the system includes a plurality of sensors and corresponding elongated sensor leads. Each sensor includes an identifier which is sent to the warning system upon detection of a water leak. The notification from the warning system includes the identifier of the sensor which detected the water leak.

### BRIEF DESCRIPTION OF THE DRAWINGS

FIG. 1 is a cross section view of a portion of a building having an ice dam.

FIG. 2 is a front view of the components of a sensor system according to an embodiment of the present invention.

FIGS. 3A and 3B are cross section views of portions of a building illustrating placement of sensors according to embodiments of the present invention.

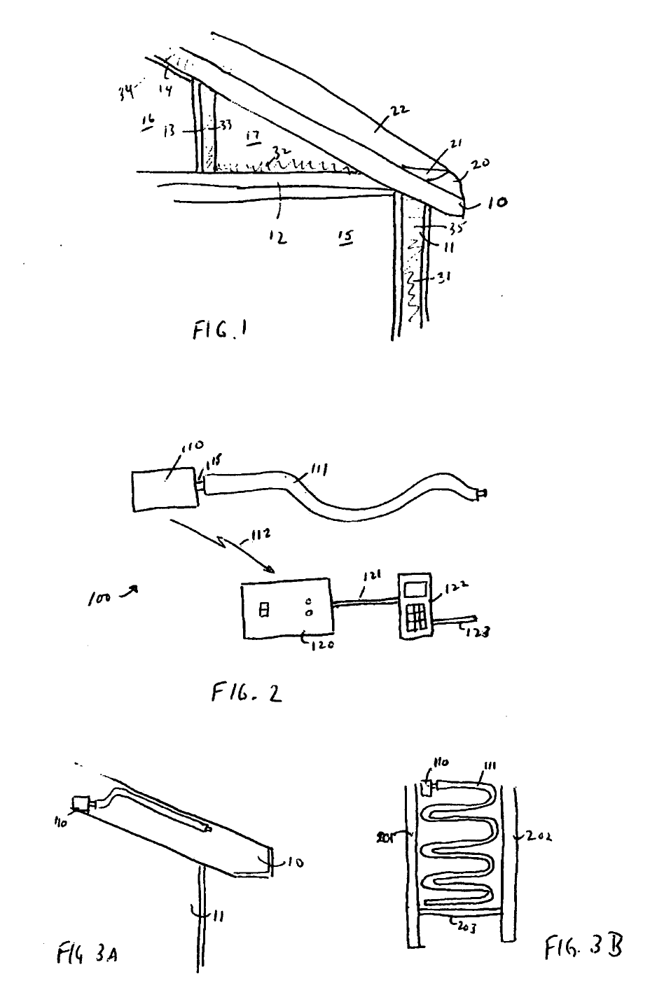

### DETAILED DESCRIPTION

The present invention, illustrated in FIG. 2, is a sensor system 100 providing an early warning of water leakage into a building as a result of ice dams. Appropriate action can be taken to remove the ice dam and/or snow to prevent further water leakage and significant damage. The sensor system 100 includes a sensor 110 having a sensor lead 111. The sensor 110 has a lead connector 115 with two wires. As is known in the art of liquid detection sensors, circuitry in the sensor 110 determines when an electrical connection is present between the two wires of the lead connector 115. Any type of sensor lead 111 may be used with the present invention. However, according to a preferred embodiment of the present invention, the sensor lead 111 is of an elongated type, such as a cable sensor, cloth sensor tape or, preferably, stainless steel sensor tape. Such elongated sensor leads have two wires within a flexible, permeable housing. When the housing becomes wet from a water leak onto the sensor lead, the two wires are electrically connected. The sensor 110 then detects the completion of the electrical circuit. Elongated sensor leads 111 may be of any length and can be up to approximately 2000 feet while providing sufficient sensing.

The sensor 110 further includes circuitry for transmitting the presence of a detected water leak. Although any circuitry or transmission medium may be used, according to an embodiment of the invention, the sensor 110 includes a radio-frequency (RF) transmitter. A receiver 120, located elsewhere in the building, receives the RF signal from the sensor 110 and provides a warning of the detected water leak. Various mechanisms can be used to warn of the water leak. The receiver 120 may include an audio alarm and/or a visual alarm. These alarms may operate continuously until manually shut off. Alternatively, the receiver 120 may include a connection 121 to an autodialer 122. The autodialer 122 is attached to a telephone line 123 and is programmed to automatically dial one or more telephone numbers upon receipt of a signal from the receiver 120. The autodialer 122 may play a recorded message when the dialed telephone is answered. Of course, the autodialer 122 could be physically combined with the receiver 120 into a single unit. Other possible warning mechanisms may also be used. For example, a text message may be sent, using appropriate devices, to a pager or email address.

When the user of the sensor system receives a warning in whatever manner is used, he or she can take appropriate action to stop further leakage, as are known. Such actions may include removing snow from the roof, removing the ice dam, and/or creating passages through the ice dam for drainage of water.

The sensor lead 111 needs to be placed at locations of possible water leaks. Since water may travel various strange paths from the exterior to the interior portion of the roof, the sensor lead 111 should cover areas which may be final locations of such leaks. FIGS. 3A and 3B illustrate possible placements of the sensor 110 and sensor lead 111 for detection of water leaks. FIG. 3A illustrates a side view of the roof structure 10 near the outside wall 11 of the building. The sensor 110 is placed on a joist of the roof, with the sensor lead 111 extending along the top of the joist near the roof. A leak through the roof where the roof is nailed to the joists would be present along the edges of the joists and detected by this sensor lead placement. FIG. 3B illustrates a second sensor lead placement. It is a bottom view of the roof between two joists 201, 202. The sensor lead 111 is placed in an S-pattern along the roof structure between the joists 201, 202 to the outside wall 203 of the building. This placement will detect leaks which occur through the nail holes from the shingles or other roofing material. Since the sensor lead may be very long, a single sensor lead may be placed in multiple patterns along and between joists to cover an entire roof or part thereof. Since ice dams occur at the eaves of the building, the sensor lead placement can be limited to areas near the outside walls of the building and do not need to extend to the ridge of the roof. However, due to the circuitous paths that leaking water may take, placement of the sensor lead solely along the roof structure at the outside wall would generally not be sufficient for complete leak detection.

The sensor 110 and receiver 120 are electric devices which require a power source. Preferably, the sensor 110 is battery operated with a long-life lithium or similar battery. Since a battery will need to be changed periodically, the sensor 110 should be placed in a location where it is reasonably accessible. Such location will depend upon the structures of the building. Alternatively, the sensor 110 may be connected to the electrical system of the building. In order to maintain monitoring capability in the event of a power outage, a sensor wired to the electrical system would include a battery backup. A battery powered sensor 110 may also include circuitry to monitor the condition of the battery. When a low battery condition is sensed, the RF transmitter may be used to send a signal to the receiver 120. The receiver 120 can provide a warning, different than that for a water leak, so that the building owner or operator is aware that the sensor battery should be changed. The receiver 120 may also be battery powered or wired to the electrical system of the building.

The sensor system 100 of the present invention has been illustrated above with a single sensor 110 and sensor lead 111. However, depending upon the size of the building and desired placement of the sensor lead, one or more sensors 110, with corresponding sensor leads 111, may be used. For example, two sensors 110 could be used on opposite sides of a building. Furthermore, the RF signals transmitted by the sensors 110 can include an identifier of the sensor. The receiver 120 can use the identifier in the RF signal for providing a specific warning as to which sensor detected a leak. In this manner, the location of the leak can be determined.

The sensor system of the present invention has been described in connection with detecting water leaks due to ice dams. However, the system is not limited to ice dams. It can be used to detect any leaks in the roof of a building. Thus, water leaks can be located and resolved early before significant leakage and damage occur. If the system is used solely for detecting leaks from ice dams, it is sufficient to operate the system only during the winter months when ice dams may form.

No specific circuitry is required for the sensor 110 and receiver 120. Appropriate circuitry can be readily devised by those of skill in the art to perform the functions required of these devices. Preferably, the circuitry would be digital and include a microprocessor for performing various of the control functions. The circuitry may also be analog. Furthermore, the sensor system has been described as having an RF link between the sensor and the receiver. These devices may be wired together for providing the signal rather than use of an RF signal.

Having described at least one embodiment of the invention, various modifications, adaptations, additions and extensions will be readily apparent to those of skill in the art. Such modifications, adaptations, additions and extensions are considered to be within the scope of the invention, which is not limited except as to the claims hereto.

1. A roof leak detection system comprising:
a water sensor having an elongated sensor lead extending therefrom, the elongated sensor lead being placed on the interior side of the roof; wherein the elongated sensor lead completes an electrical circuit within the sensor when any portion of the elongated sensor lead becomes wet; and wherein the water sensor includes means for sending a signal when the electrical circuit is completed; and
a warning system including:
a receiver for receiving the signal from the sensor; and
a notification system providing an indication of detection of a water leak.

2. The roof leak detection system according to claim 1, wherein the signal is a radio frequency signal.

3. The roof leak detection system according to claim 1, wherein the notification system includes an audio alarm.

4. The roof leak detection system according to claim 1, wherein the notification system includes a visual alarm.

5. The roof leak detection system according to claim 1, wherein the notification system includes an autodialer for dialing a preprogrammed telephone number.

6. The roof leak detection system according to claim 1, wherein the elongated sensor includes a tape sensor.

7. The roof leak detection system according to claim 6, wherein the elongated sensor includes a stainless steel tape sensor.

8. A roof leak detection system comprising:
a plurality of water sensors, each having an elongated sensor lead extending therefrom, the elongated sensor leads being placed on the interior side of the roof; wherein each elongated sensor lead completes an electrical circuit within a corresponding sensor when any portion of the elongated sensor lead becomes wet; and wherein each water sensor includes means for sending a signal including an identifier when the electrical circuit is completed; and
a warning system including:
a receiver for receiving signals from the plurality of water sensors; and
a notification system providing an indication of detection of a water leak.

9. The roof leak detection system according to claim 8, wherein the notification system provides an indication of the identifier of the sensor which sent the signal.
